(19) United States
(12) Patent Application Publication
(10) Pub. No.: US 2008/0270208 A1
(43) Pub. Date: Oct. 30, 2008

(54) SYSTEM AND METHOD FOR THE MANAGEMENT OF MULTIPLE AGENCY RESOURCES

(75) Inventors: Kyle Kuczun, Boulder, CO (US); Douglas Zimmerman, Littleton, CO (US); Rhonda Ford, Louisville, CO (US); Josh Riney, Boulder, CO (US); Jeff Bohmer, Boulder, CO (US); Zac Sackrison, Longmont, CO (US)

Correspondence Address: Neugeboren O''Dowd PC, 1227 Spruce Street, SUITE 200, BOULDER, CO, 80302, US

(73) Assignee: VISIONLINK, INC., Boulder, CO (US)

(21) Appl. No.: 12/109,004

(22) Filed: Apr. 24, 2008

Related U.S. Application Data
(60) Provisional application No. 60/914,363, filed on Apr. 27, 2007.

(51) Int. Cl. G06Q 10/00; G06F 17/30; G06F 17/40

(52) U.S. Cl. 705/7

(57) ABSTRACT

A system and method for managing data pertaining to a plurality of organizations and a plurality of facilities, the method comprising obtaining facility identifying information from the plurality of facilities and creating a facility identity record, obtaining population information from the plurality of facilities and creating a population record, obtaining event identifying information from the plurality of facilities and creating an event record, and associating the facility identity record, the population record, and the event record with one or more of the plurality of organizations.

### CROSS REFERENCE TO RELATED APPLICATION

This application is based upon, and claims priority to U.S. Provisional Patent Application No. 60/914,363, entitled System and Method for the Management of Housing and Shelter Data, filed Mar. 27, 2007. The entirety of such provisional patent application, including all exhibits and appendices thereto, are incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to a system and method for planning, tracking, supporting and reporting information about multiple relief facilities, and more particularly to disaster shelters before, during, and after a disaster in real-time.

### BACKGROUND OF THE INVENTION

Current State of the Art. Across the United States, formal and informal systems exist to manage nearly 50,000 disaster shelters. These shelters are frequently reviewed and certified by organizations such as the American Red Cross, the Federal Emergency Management Agency (FEMA), and other organizations, as to their capacity to support a certain number of people and the type of services and facilities offered at each particular shelter. Shelters also spontaneously arise, as when people congregate at a local church or school during a disaster.

Many organizations work to review, certify, prepare and manage disaster shelters. The American Red Cross is largely responsible for this work, yet other organizations such as FEMA, other faith-based groups, and local emergency response agencies and officials are also involved.

While disaster shelters are typically maintained and managed locally, the national offices of organizations such as the Red Cross and FEMA require up-to-date information about shelter availability and capacity. This is necessary, particularly during large scale disasters, so that resources to support the shelters and their occupants can be coordinated, and information about the shelter's capacity, facilities, and current population can be communicated with local, state, and national officials.

Across the United States, some 70,000 or more disasters occur every year. These range from single family and apartment building fires which displace their occupants, to larger floods, storms, hurricanes, and occasionally to very large scale, multi-state catastrophic disasters.

As a disaster unfolds, response is initially locally managed. As an apartment fire displaces it's occupants, and as local police, fire, and medical personnel engage, sheltering and other support is often provided by the local chapter of the American Red Cross, or by a local church, or by one or more of the thousands of other nonprofit, charitable, or faith-based groups involved with disaster response.

If the disaster spreads, for example, if the apartment fire has actually been caused by a forest fire in the area, then state and national resources may be engaged to coordinate response, and specific to the sheltering situation, many different shelters may open. These might include both formal and spontaneous shelters. Complexity arises from the fact that shelters are initially opened and supported at the local level based on immediate need, and these shelters, both formal and spontaneous, are opened by many different organizations. As the disaster unfolds, it becomes necessary to account for what shelters are available, supported by which organizations, providing certain kinds of services, for a constantly changing population of individuals and families.

Logistical Issues. As these formal and spontaneous shelters emerge, logistical issues surface quickly. The shelters are typically a combination of formal facilities with known capacities, official points of contact and so forth, while other shelters spontaneously emerge in nearby buildings that may have temporarily spaces for sleeping, feeding, and other kinds of support.

Further, as the formal and spontaneous shelters form, this process typically happens concurrently through several different organizations. For example, the local chapter of the Red Cross would typically be opening a shelter; a neighboring church or school may also open its doors, and some other organization from a city or county government, or the local representatives of FEMA may open shelters as well.

Often, more than one organization may be offering services in the same facility, concurrent with another organization. For example, the multiple organizations might determine that in one particular shelter, the space in several classrooms will be managed by FEMA, while the space in the gymnasium will be managed by the Red Cross.

As the shelters open, and as a disaster affects more families and individuals, the availability of information about shelter capacity and the types of facilities available, becomes critical. Information about the current population of the shelter(s) is necessary to provide food, cots, and other services. Information about the shelter(s)'s capacity becomes critical as local emergency officials need up-to-date information about where victims can be sent or taken for shelter. And information about the types of facilities and amenities available at a particular shelter becomes critical as relief groups determine whether food can be prepared, whether showers are available, whether families can be grouped together, and whether medical services are available, among various other factors.

The problem is that each responding organization such as the Red Cross or FEMA have it's own internal procedures and mechanisms to manage the sheltering services they provide such as managing staff and responding to donors. Each such group has an organizational mandate to manage their donations, volunteers, local chapter resources and communications about the sheltering operation. These procedures are organizationally specific and typically do not overlap or synchronize with other organizations.

Thus, when more than one organization is providing sheltering in a local area, and where more than one organization is providing sheltering services, concurrently, in the same facility, information flow has been severely mitigated and a need exists to better manage this information. Each organization could manage it's own internal communication and work flow, but not know of the other organization's shelter resources, capacity, bed counts and so forth resulting in a large level of old or incorrect information being distributed to the organizations.

These problems compound at an additional level. Since disasters are not well-behaved, it is possible to have sheltering services being provided in an area for flood victims, at the same time that a shelter needs to be provided for passengers on a train that has derailed, or for an apartment building fire. The supporting organizations need to manage their resources and information on a disaster-specific basis for a variety of reasons, including, but not limited to, donor fund management.

Thus, to manage availability, capacity, and dissemination of this information for each specific disaster and across multiple organizations, a solution is necessary that not only allows responding organizations access to information for their own internal processes, across multiple shelters and multiple disasters, but to do so in a manner that allows each responding organization to access unified information, such as capacity, for each shelter, regardless of the number of organizations providing services, and regardless of the specific disaster(s) to which victims in a shelter were related.

### SUMMARY OF THE INVENTION

In accordance with one or more aspects of the present invention, a unified shelter management solution allows shelter residents to be counted and reported in such a way that each providing organization's disaster-specific identification system can be maintained, and in such a way that each providing organization's population counts can be maintained (how many beds are provided by their organization), and in such a way that the collective capacity and population of the shelter(s) across all of the responding organizations can be counted, summed, and disseminated, collectively.

Thus, shelter status and capacity can be known for the part of a single facility managed by a given organization, and the victims in the shelter supported by a single organization can be known, and the collective population of the shelter supported by all the responding organizations can be known and communicated in total. In this manner, local emergency officials can know a single count of total capacity and current shelter population, while each participating organization can know of the facilities, parts of facilities, and individuals and families which it is directly, and separately, supporting.

In one aspect a system for managing data pertaining to a plurality of organizations and a plurality of facilities, comprises a processor, a memory structure for storing a database of information coupled to the processor, a computer readable medium coupled to the processor and having computer executable instructions for performing a method, the method comprising obtaining facility identifying information from the plurality of facilities and creating a facility identity record, obtaining population information from the plurality of facilities and creating a population record, obtaining event identifying information from the plurality of facilities and creating an event record, and associating the facility identity record, the population record, and the event record with one or more of the plurality of organizations.

In another aspect, a system for managing data pertaining to a plurality of relief organizations and a plurality of shelter facilities, comprises a data storage device containing an agency record for storing information pertaining to at least one relief organization, a user account record coupled to the agency record for storing access permission credentials corresponding to a plurality of users, a resource directory record coupled to the agency record for storing service and program information associated with the at least one relief organization and a shelter record coupled to the agency record for storing relief shelter services information pertaining to at least one relief shelter, wherein the system is adapted to consolidate the access permission credentials, the service and program information, and the relief shelter services information, and provide a consolidated report containing relief shelter services information for a particular relief organization.

In yet another aspect, A method of managing multiple agency resources, comprises obtaining facility information pertaining to a disaster relief facility, creating a facility identity record, obtaining population information pertaining to a disaster relief facility, creating a facility population record, obtaining event identifying information pertaining to a disaster event, creating an event record; associating the facility identity record, the facility population record and the event record with a relief organization, and transmitting the associated information to the relief organization.

Numerous other aspects, embodiments, variations, and substitutions may be made in the invention, its use and its implementation to achieve substantially the same results as achieved by the embodiments described herein.

### BRIEF DESCRIPTION OF THE DRAWINGS

Various objects and advantages and a more complete understanding of the present invention are apparent and more readily appreciated by reference to the following detailed description and to the appended claims when taken in conjunction with the accompanying drawings wherein:

FIG. 1 is a system level diagram of a prior art facility management system;

FIG. 2 is a system level diagram showing how various organizations gain access to information pertaining to one or more facilities;

FIG. 3 is a system level diagram of a facility management system in accordance with one aspect of the present invention;

FIG. 4 is a table showing one embodiment of the database structure of a facility management system in accordance with one aspect of the present invention;

FIG. 4A is a diagram showing the relationship of various tables and fields used in conjunction with a system for managing a collection of facilities in accordance with aspects of the present invention;

FIG. 5 is a system wide architecture diagram of a facility management system in accordance with one aspect of the present invention;

FIG. 6 is a flow chart depicting a method of managing a collection of facilities in accordance with various aspects of the present invention; and

FIGS. 7-12 are system interface embodiments of various aspects of a facility management system constructed in accordance with aspects of the present invention.

### DETAILED DESCRIPTION

In general, a facility management system constructed in accordance with various aspects of the present invention provides a mechanism to associate shelters (or various other relief or resource facilities) to multiple Disaster Relief Operation (DRO) numbers (or other unique identification numbers) and to particular managing organizations, such as a relief organization, and to associate a DRO number (or another unique identification number) to multiple shelters. Such features allow population counts and other facility statistics to be tracked separately for different relief organizations, even when using the same shelters and for multiple shelters allocated to the same disaster. In the broadest sense, this functionality is achieved through the use of an interface that accepts and verifies the DRO number and population entered, and inserts the data into a group of related tables for processing and correlation to a particular managing organization.

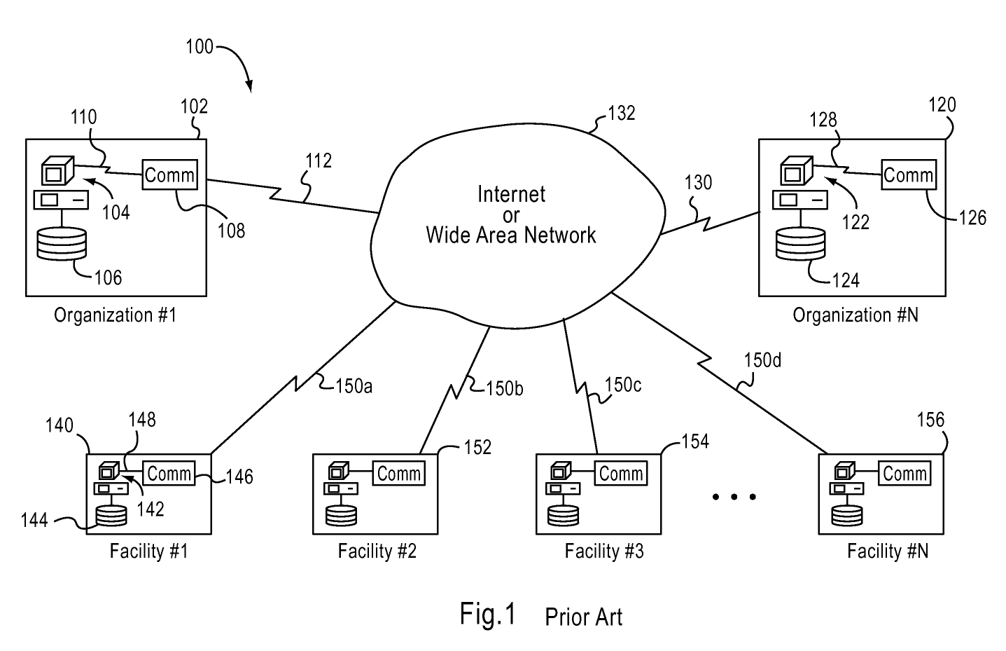

With reference to the drawing figures, FIG. 1 shows a communication and management system 100 designed to receive and organize information pertaining to one or more facilities 140, 152, 154 and 156. Systems such as the one depicted in FIG. 1 have been known, and such a system can apply to any number of facilities as well as any number of different types of facilities, such as shelters, food service centers, homeless and temporary housing, emergency medical facilities, churches, schools, as well as the more typical large scale disaster shelters used in case of natural disaster, disease outbreak, etc. Of particular note in the system of FIG. 1 is that a particular organization (e.g. organization 102) can not parse facility/shelter information based on any particular event, disaster or DRO, cannot see whether any other organizations are maintaining operations at any given facility, and cannot see what portion of any particular facility is being administered by any other organization.

An organization 102, such as the American Red Cross, The Federal Emergency Management Agency (FEMA) or any other relief organization, maintains its own management facility or other location that includes one or more user computer terminals 104, including some type of data storage 106 and a communications port 108 connected via a communications channel 112 to the internet or other form of wide area network 132. Additional organizations 120 include a similar structure as that of the organization 102. It is contemplated that any number of organizations may exist and function in conjunction with a system and method in accordance with aspects of the present invention. The example shown in FIG. 1 is only meant to be representative of the overall structure of the system.

The facility 140 also includes user computer terminals 142, including some type of data storage 144 and a communications port 146 connected via a communications channel 150a to the internet or other form of wide area network 132. Facility 140 represents one of many different types of disaster relief facilities or shelters such as facilities managed by federal, state or local organizations (e.g. the Red Cross, FEMA, etc.) or any number of local and regional shelters such as churches and other faith-based facilities, schools, community centers, and other facilities whose day to day operations are other than providing shelter or disaster relief. As with the organizations described above, it is contemplated that any number of facilities or shelters 152, 154 and 156 may be used in accordance with one or more aspects of the present invention. The examples given in FIG. 1 and throughout this description are by no means meant to be limiting to the scope of the attached claims.

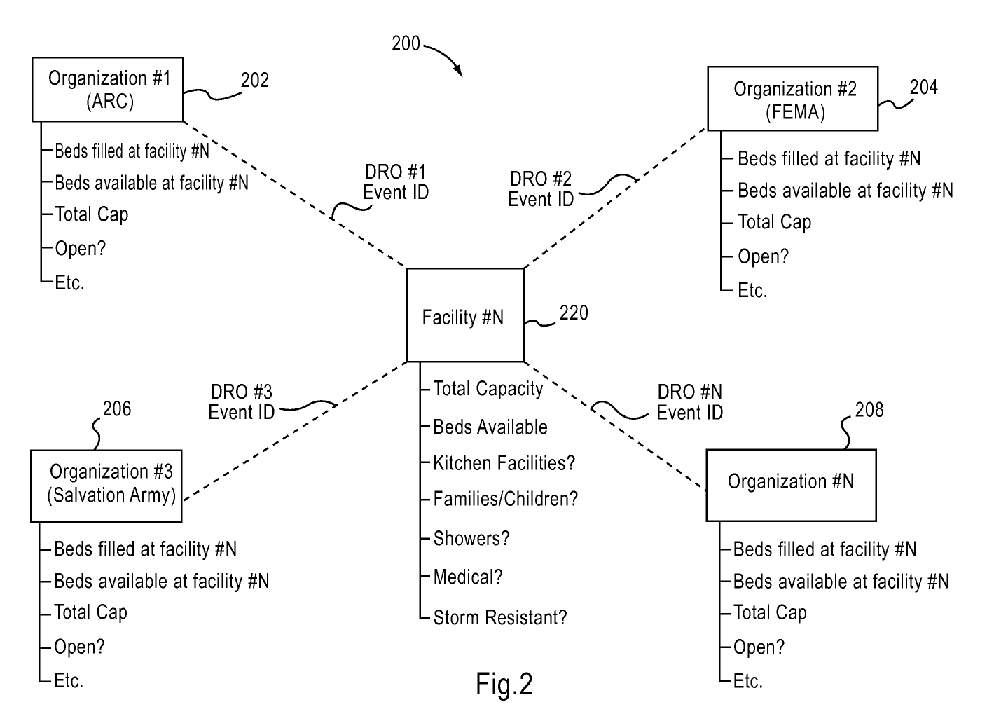

In practice, each of the facilities 140, 152, 154 or 156 enter data through a computer system pertaining to the status of the shelter being operated by that particular facility. For example, and in reference to FIG. 2, a particular facility 220 (Facility #N), has access to, and keeps updated information about various types of information such as the total capacity of the shelter, the number of beds available at a particular point in time, whether kitchen facilities are available, whether the facility accepts families and/or children, whether there are showers or bathing facilities available, whether and to what extent medical facilities are available, whether the shelter is built to particular building code standards so as to be resistant to storms or other whether related issues, as well as any other information that is particular to the facility 220. Organizations 202, 204, 206 and through 208, may represent a variety of relief or other support organizations at either the local, regional, state, federal or private level, such as the Red Cross, FEMA or any other relief organization that can access the system. Each organization in practice assigns a unique identification number and event name to any particular disaster or other event that might require their resources. In the example of FIG. 2, this identifier is referred to as a Disaster Relief Operation number (DRO), a term commonly used in the field. While each organization may maintain its own database of information as to the status of the resources it is dedicating to any particular facility 220, in practice, each organization assigns a unique DRO number (often times having a unique alphanumeric format) and unique event name/ID to a particular disaster or relief effort. The result is that a particular event or disaster may have several different identifiers associated with it from an assortment of organizations. In addition, several facilities might be utilized for a particular event or disaster giving rise to a situation where the same DRO number is used across more than one facility.

While each organization might have access to the status of its own activities at any particular facility 220, it typically does not have access to the activities of other relief organizations that might be operating at the same facility.

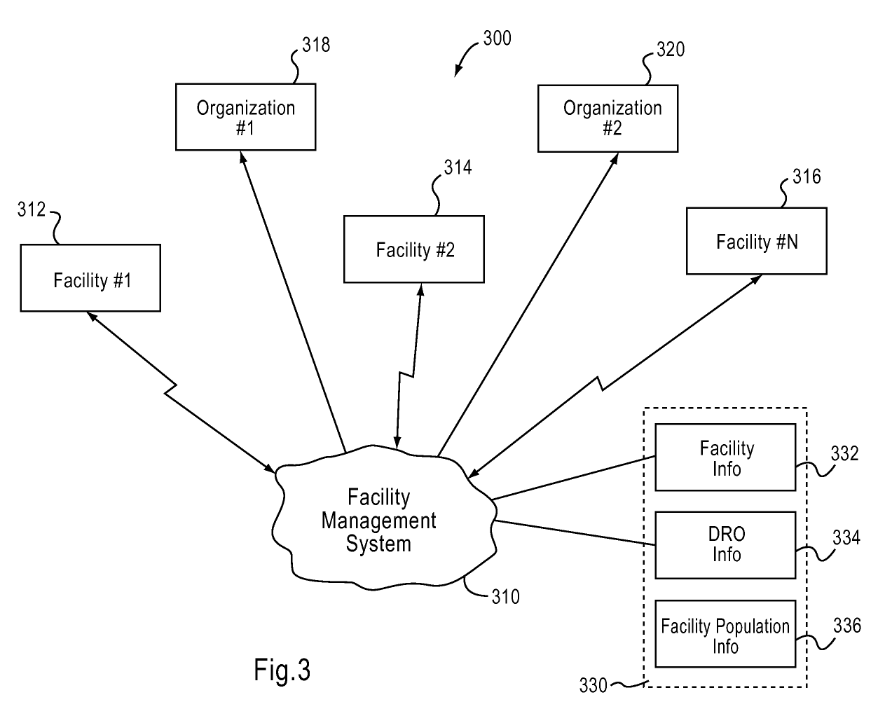

FIG. 3 shows a generalized view of a facility management system 310 and how such a system works to consolidate and provide real-time updated information related to an array of facilities 312, 314, and 316, regardless of which of the organizations 318 and/or 320 might be conducting activities at any particular facility. By utilizing a computer implemented process stored in a computer readable form, in conjunction with a database 330, consisting of facility information 332, DRO information 334 and facility population information 336, the system 310 can provide information to any of the organizations pertaining to the complete status of any particular facility, including all organizations providing services at that facility, the proportion and part of the facility being used by a particular organization, and a consolidated form of data concerning the usage of that particular facility. Each of the facility management system 310, the organizations 318 and 320, and the facilities 312, 314, and 316 are interconnected via a wide area network such as the internet. Information may be distributed via both hard wired communication or any of the know wireless communication protocol as well as via a PC-type terminal or any of the known hand held type devices, cell phone or PDAs that provide similar functionality.

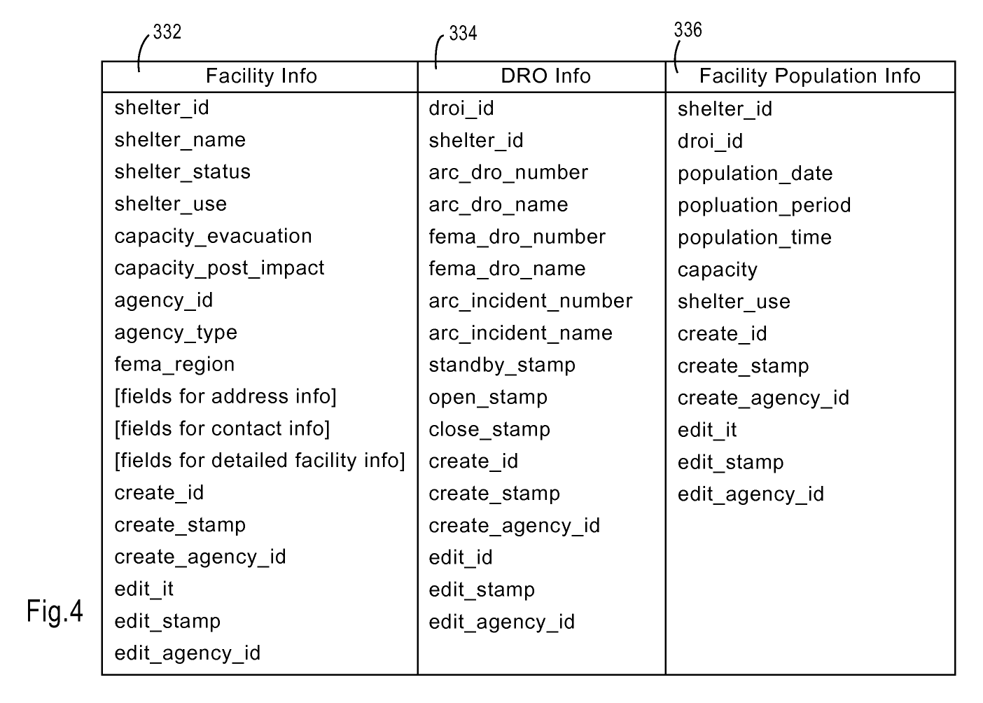

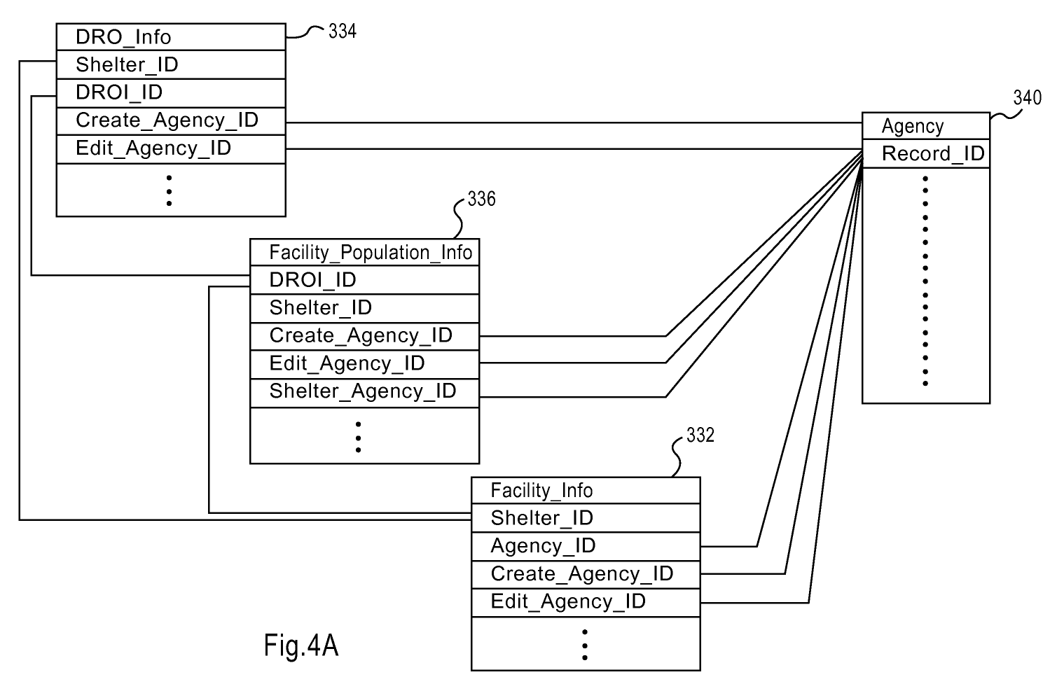

With reference to FIG. 4, a more detailed view of the tables 332, 334 and 336 from database 330 are shown. The tables shown in FIG. 4 facilitate the entering of disaster relief information into the system and facilitate the ability of the system to manage information pertaining to a plurality of facilities. The Facilities Information table 332 contains information about the shelter facility. For DRO Management purposes, the Shelter_id field from this tables associates DRO and population information to a specific shelter. This table also contains fields for the shelter_status (Open, Closed, Standby, Inactive), shelter_use (evacuation or post-impact), and the capacity_evacuation and capacity_post_impact fields which contain the capacity population for each types of possible shelter use. In addition, basic information about the organization(s) managing the shelter is kept in this table in the agency_type and fema_region fields.

The DRO Information table 334 contains information about the DRO names and numbers for each relief organization, and standby, open and close dates and times for each shelter/DRO combination. The table contains a shelter_id column that links the DRO information in this record to a specific shelter. A separate record is created for each shelter/DRO combination.

The Shelter Population table 336 contains population counts for each record in the shelter_droi table. The shelter_id and droi_id link to the shelters and shelter_droi tables. The composite primary key consists of shelter_id, droi_id, population_date and population_period. This ensures that only one population count can be entered for each shelter/DRO combination per period per day. The shelter_use and capacity fields are copied from the shelters table at the time the population record is created to maintain a history of the shelter use at the time the population was added.

FIG. 4A shows the relationship between various fields in the above tables and how an agency record id is created based on the information gathered from both the individual facilities and the organizations assigning a DRO or other unique identifier to the particular event or disaster. The agency table 340 is a separate entity in the system meant to contain information about an organization that manages shelters and has people associated to it who will log in to the system. The relationship to the rest of the system is that every shelter and every user id is owned by an agency. The agency record preferably exist in the system before a shelter or user id can be associated with it.

This relationship can be used to create reports on all shelters associated with an agency or group of agencies. In addition, it is of interest to know which agency a user is associated to when updating the information in the system, especially since there is not a limitation that users can only update shelters that are owned by the same agency as their user id.

Disaster relief information consists of a Disaster Relief Operation (DRO) name and number created by each managing organization for each disaster. When entering DRO information into the system, the system interface receives at least one DRO name and number pair to be associated with a shelter before population can be added for that shelter. The DRO information should be entered as a name/number pair. At least one DRO must be entered, and the number is validated against the corresponding standard number format for the relief organization.

The DRO information is kept in the DRO Info table 334. The table contains a field for each DRO name and number for each relief organization, and a record is added to the table for each shelter/DRO combination. Duplicate shelter/DRO combinations should not be allowed, so when a record is added to this table, the system verifies that the shelter/DRO combination is unique. Each record contains standby, open and close dates for each shelter/DRO combination to enable flexibility in tracking and reporting for shelter and DRO geographic and/or organizational combinations. Dates entered must be in a valid date format and must make sense. For example, a shelter DRO cannot be closed before it is opened.

Entering Population Information. After a shelter is associated with one or more DROs, shelter population can be entered for each DRO. The interface prompts for a date and count to be entered. The date is validated to make sure it is a date and it fits the date range criteria. For example, the date can be up to 30 days in the past or 8 hours in the future. Population for each shelter/DRO can preferably be entered multiple times per day, with each count being associated with a population period in the database. An optional time of population count can also be entered, but if not entered, the system will set the time of the count to midnight. The system preferably prevents population from being entered if a shelter has a status of closed. Capacity information is displayed while entering population, but the system will allow a total population to exceed the listed capacity for the shelter.

The population information is kept in the facility population table 336. The table contains the shelter_id and droi_id that will associate the population to the correct shelter/DRO combination. A record is added to the table for each population date and period requested. In addition, the shelter_use and associated capacity field (capacity_evacuation or capacity_post_impact) are copied to the facility population table every time population is added to maintain history of how the shelter was being used when population was added.

Deleting Shelter, DRO or Population Information. Shelters, DROs and Population information can be deleted from the active system, but are still maintained for reporting purposes. When a Shelter, DRO and/or Population record is deleted, it is inserted into the corresponding shelters_deleted, shelter_droi_deleted or shelter_population_deleted table. This allows each organization to have an audit of all shelter, dro, and population information. The delete is hierarchically aware, meaning that if a DRO is deleted, all associated population is also deleted. If a shelter is deleted, any DRO or population associated with that shelter will also be deleted (moved to the corresponding deleted tables).

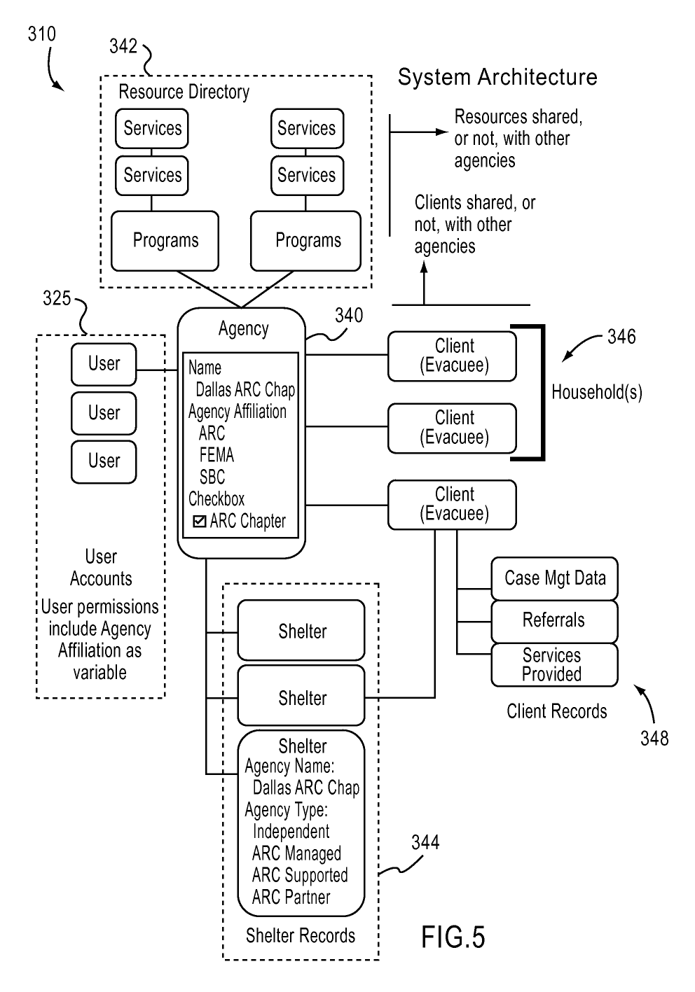

FIG. 5 shows an overall and high level system architecture of the facility management system 310. The system 310 includes an agency module/table 340, a shelter record module 344, one or more user account modules 325, household module 346, client record module 348, and resource directory module 342. The interrelation of these various components is shown at a high level by the interconnecting lines within FIG. 5.

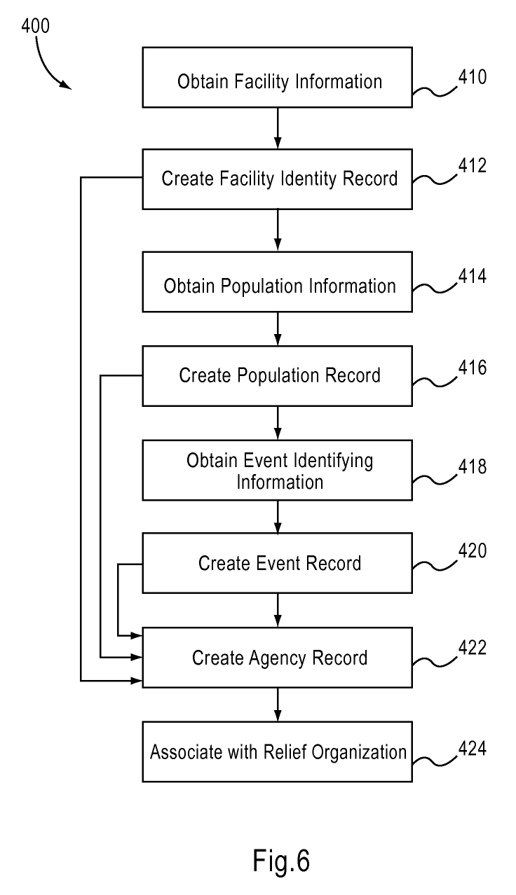

FIG. 6 shows an embodiment of the process flow 400 for a facility management system in accordance with one aspect of the present invention. At step 408 the system obtains agency facility information and creates an agency record at 422. At step 410 the system obtains facility information via one or more embodiments of a user interface and accompanying database structure. A facility identity record is created at 412 based on this information. At 418, event or DRO identifying information is obtained and an event record is created at 420. At 414 the system obtains population information about a particular facility or shelter, again through one or more embodiments of a user interface and database structure. At 416 a population record is create from the inputted facility population information. Based on the facility identity record, the population record and the event record an agency record is updated at 422 and the population record is associated to a facility and event record at 424. Event identification information is updated at 426. In some situations, certain steps occur prior to a disaster and certain others occur during or after a disaster has occurred as indicated in FIG. 6.

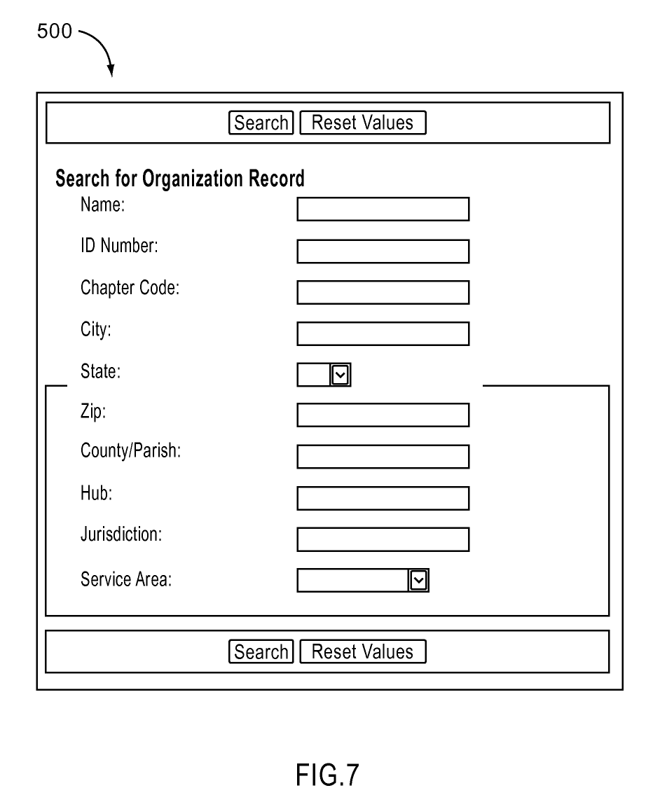

Several Examples of an interface that can be used in conjunction with aspects of the present invention are included in FIGS. 7-12. These user interfaces are meant as examples only and it is contemplated that one of skill in the art could design a variety of user interfaces that would enable one to accomplish the aspects of the present invention. A system constructed in accordance with various aspects of the present invention will preferably have one or more of the following features or capabilities:

The ability to allow a user to register and manage his account through a password protected secure web or other network interface.

The ability for registered users to use the system to search for organization records. See for example, FIG. 7 at 500.

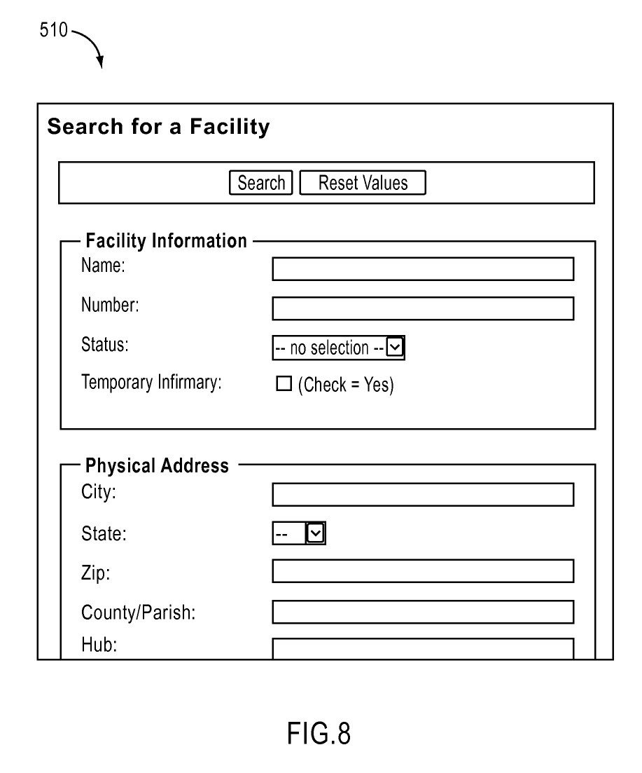

The ability for registered users to use the system to enter new, update existing and delete facility/chapter information. See for example, FIG. 8 at 510.

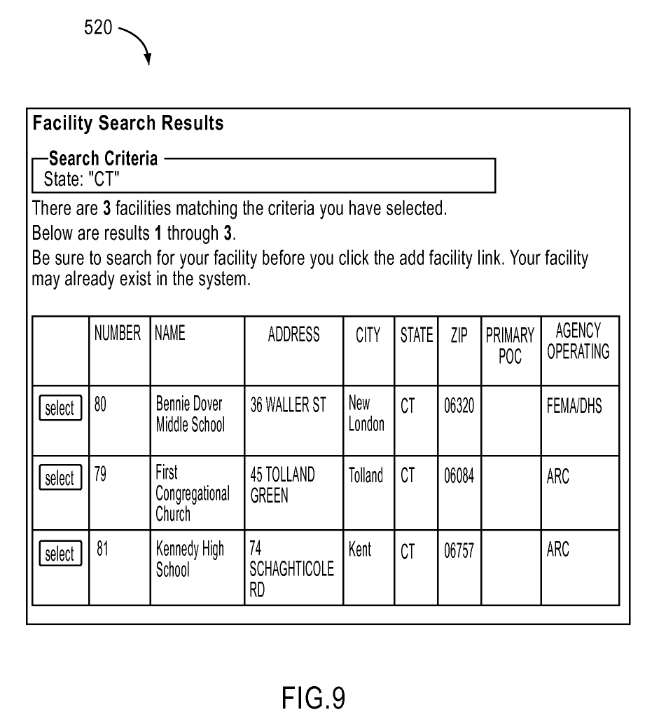

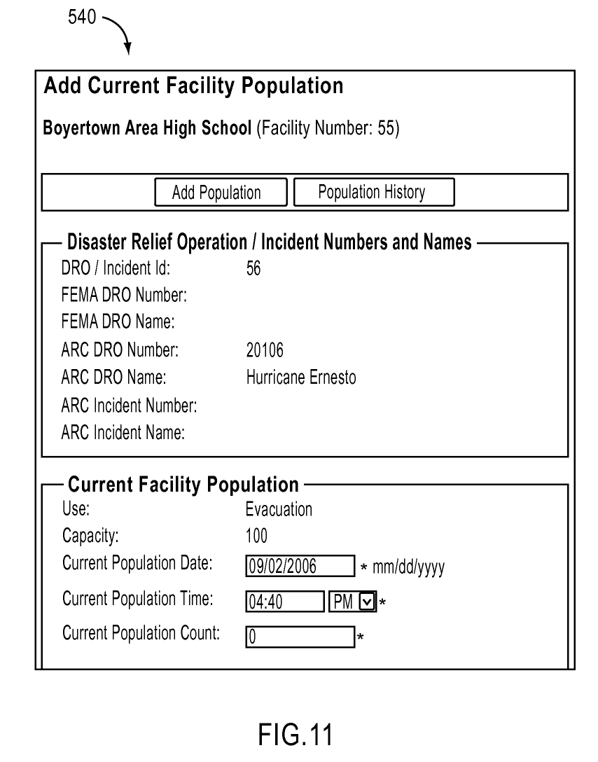

The ability for registered users to use the system to search for information about specific facilities across the country and to add, update and/or delete facility information. See, for example, FIGS. 9 and 11 at 520 and 540.

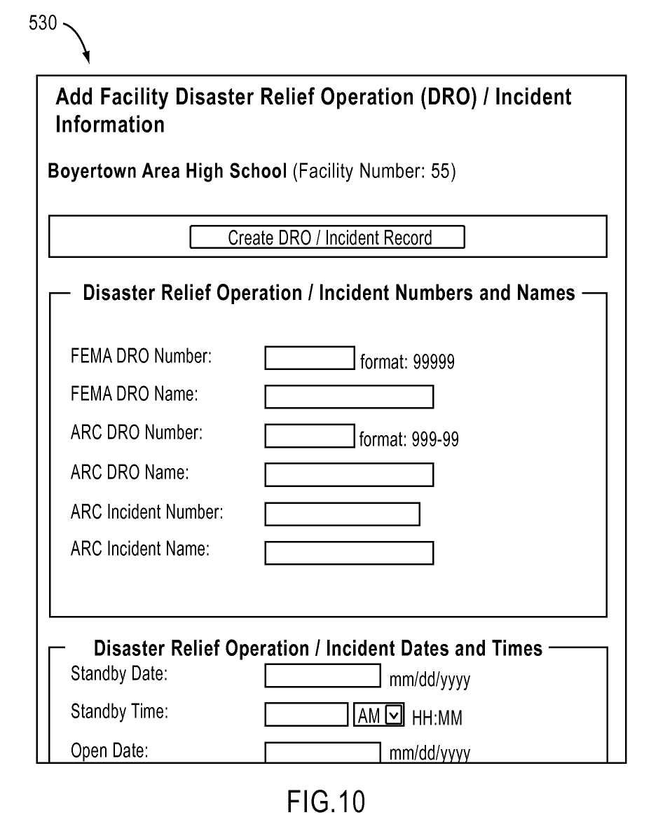

The ability for registered users to use the system add, update and delete Disaster Relief Operations (DROs)/Incidents information. See, for example, FIG. 10 at 530.

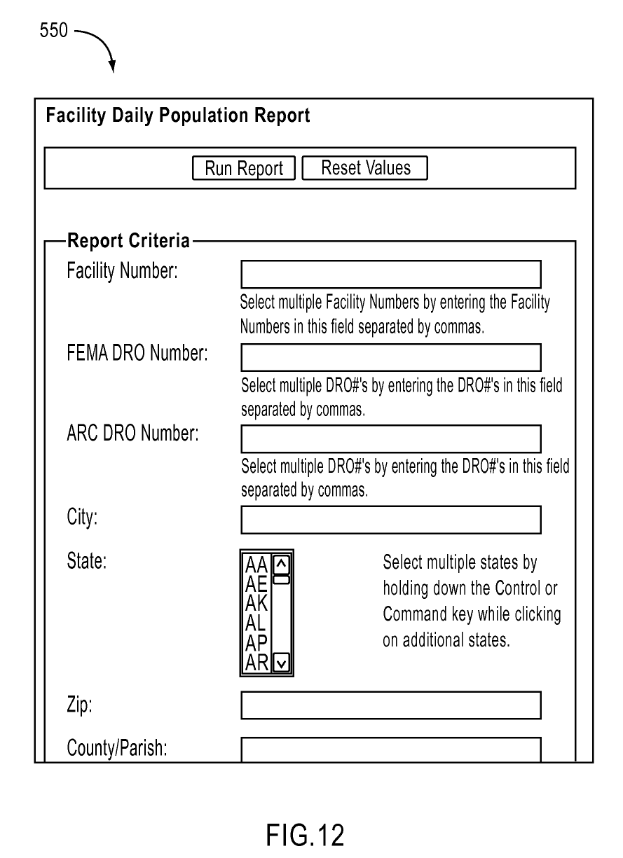

The ability for registered users to use the system to view, add update and delete population counts for a Disaster Relief Operation\Incident. See, for example, FIG. 12 at 550.

The ability for registered users to use the system to run various reports on shelter inventory, current shelter population and shelter peak population.

The ability for registered users to use the system to export data from the database for decision-making, trend analysis, and research purposes.

In accordance with another aspects of a system and method in accordance with the present invention, functionality is incorporated into the system to check for shelters with the same standardized name and address when a shelter is added or updated. When adding or updating a shelter, the Shelter Name and Address are preferably compared to all other shelters in the same zip code to look for a match. Both the new and the old names and addresses are standardized before a compare by changing the names to lower case, removing punctuation, combining multiple blanks, and changing common abbreviations to words (e.g., 1st to first, av or ave to avenue, rd to road, etc.) If a match is found, an error message is displayed, listing the duplicate shelters. The existing shelters can be viewed in another window to allow the user to compare existing and new. The user is allowed to create the shelter if they are sure that it is not really a duplicate of existing shelters.

Other aspects of a system, device, and method constructed in accordance with the present invention include the ability to search facility information, add and update facility information, manage DRO incidents, manage population counts at a facility, export facility information for one or more reporting purposes, flag facilities for one or more reasons, provide various levels of user account access and rights privileges, and provide community account and calendaring features to allow users to communicate with each other about local efforts, response schedules, training and other related information.

Those skilled in the art can readily recognize that numerous variations and substitutions may be made in the invention, its use and its implementation to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A system for managing data pertaining to a plurality of organizations and a plurality of facilities, comprising:
a processor;
a memory structure for storing a database of information coupled to the processor;
a computer readable medium coupled to the processor and having computer executable instructions for performing a method, the method comprising:
obtaining facility identifying information from the plurality of facilities and creating a facility identity record;
obtaining population information from the plurality of facilities and creating a population record;
obtaining event identifying information from the plurality of facilities and creating an event record; and
associating the facility identity record, the population record, and the event record with one or more of the plurality of organizations.

2. The system of claim 1, further comprising associating the facility identity record, the population record, and the event record with a plurality of disaster relief organizations, and transmitting the collective information to one or more of the plurality of disaster relief organizations.

3. The system of claim 1, further comprising creating an agency record that is distinct from the facility identity record, the population record, and the event record, and wherein the agency record contains information about one of the plurality of organizations.

4. The system of claim 3, wherein at least one of the plurality of organizations is a disaster relief organization.

5. The system of claim 1, wherein the method further comprises creating a plurality of facility identity records, creating a plurality of population records and creating a plurality of event records.

6. The system of claim 3, wherein the method further comprises generating a report containing facility identity records associated with a single relief organization.

7. The system of claim 1, wherein the method further comprises providing a user interface that allows management organization data to be modified within the facility identity record.

8. The system of claim 1, wherein the method further comprises providing a user interface that allows facility identifying information to be modified within the at facility identity record.

9. The system of claim 1, wherein the method further comprises providing a user interface that allows population information to be modified within the population record.

10. The system of claim 1, wherein the method further comprises providing a user interface that allows event identifying information to be added to the event record.

11. The system of claim 1, wherein the event identifying information is disaster relief operation (DRO) information.

12. The system of claim 11, wherein the event identifying information further comprises an event identification name.

13. The system of claim 1, wherein the organizations are government relief organizations.

14. The system of claim 1, wherein the facilities are disaster relief shelters.

15. A system for managing data pertaining to a plurality of relief organizations and a plurality of shelter facilities, comprising:
a data storage device containing an agency record for storing information pertaining to at least one relief organization, a user account record coupled to the agency record for storing access permission credentials corresponding to a plurality of users, a resource directory record coupled to the agency record for storing service and program information associated with the at least one relief organization and a shelter record coupled to the agency record for storing relief shelter services information pertaining to at least one relief shelter;
wherein the system is adapted to consolidate the access permission credentials, the service and program information, and the relief shelter services information, and provide a consolidated report containing relief shelter services information for a particular relief organization.

16. A method of managing multiple agency resources, comprising:
obtaining facility information pertaining to a disaster relief facility;
creating a facility identity record;
obtaining population information pertaining to a disaster relief facility;
creating a facility population record;
obtaining event identifying information pertaining to a disaster event;
creating an event record;
associating the facility identity record, the facility population record and the event record with a relief organization; and
transmitting the associated information to the relief organization.

17. The method of claim 16, wherein obtaining facility information pertaining to a disaster relief facility further comprises obtaining information corresponding to available bed space and total bed space.

18. The method of claim 16, wherein obtaining event identifying information pertaining to a disaster event further comprises obtaining a disaster relief operation (DRO) identifier.

19. The method of claim 18, further comprising obtaining an event name.

20. The method of claim 16, further comprising transmitting the associated information to a plurality of relief organizations.
